(19) United States
(12) Patent Application Publication
(10) Pub. No.: US 2014/0004221 A1
(43) Pub. Date: Jan. 2, 2014

(54) NANOIMPRINTING MOLD

(71) Applicant: FUJIFILM Corporation, Tokyo (JP)

(72) Inventors: Naotoshi SATO, Haibara-gun (JP); Tadashi OMATSU, Haibara-gun (JP); Satoshi WAKAMATSU, Haibara-gun (JP)

(73) Assignee: FUJIFILM Corporation, Tokyo (JP)

(21) Appl. No.: 14/019,754

(22) Filed: Sep. 6, 2013

Related U.S. Application Data
(63) Continuation of application No. PCT/JP2012/056779, filed on Mar. 9, 2012.

(30) Foreign Application Priority Data
Mar. 10, 2011 (JP) 2011-052859

(51) Int. Cl. B29C 59/02

(52) U.S. Cl. CPC B29C 59/02
USPC 425/385

(57) ABSTRACT

A nanoimprinting mold has a fine pattern of protrusions and recesses constituted by a plurality of linear protrusions and a plurality of recesses on the surface thereof. The pattern of protrusions and recesses includes at least one recess having an end portion of a predetermined shape. The predetermined shape is that which has a cross section with a smaller aspect ratio than an aspect ratio of a cross section of a connecting portion, which is a portion of the recess having the end portion other than the end portion and continuous therewith. Thereby, the collapse of the end portions of protrusions of a pattern on curable resin when a mold is pressed against the curable resin on a substrate then separated therefrom can be suppressed, in nanoimprinting that employs a mold having a predetermined fine pattern of protrusions and recesses on the surface thereof.

### TECHNICAL FIELD

The present invention is related to a a mold having a fine predetermined pattern of protrusions and recesses on the surface thereof.

### BACKGROUND ART

There are high expectations regarding utilization of pattern transfer techniques that employ a nanoimprinting method to transfer patterns onto resist coated on objects to be processed, in applications to produce magnetic recording media such as DTM (Discrete Track Media) and BPM (Bit Patterned Media) and semiconductor devices.

The nanoimprinting method is a development of the well known embossing technique employed to produce optical discs. In the nanoimprinting method, a metal original (commonly referred to as a mold, a stamper, or a template), on which a pattern of protrusions and recesses is formed, is pressed against curable resin coated on an object to be processed. Pressing of the original onto the resist causes the resist to mechanically deform or to flow, to precisely transfer the fine pattern. If a mold is produced once, nano level fine structures can be repeatedly molded in a simple manner. Therefore, the nanoimprinting method is an economical transfer technique that produces very little harmful waste and discharge. Therefore, there are high expectations with regard to application of the nanoimprinting method in various fields.

Conventionally, it is an important objective to improve the pattern formation properties on curable resin (the ease with which a pattern of protrusions and recesses can be formed on the curable resin according to design), accompanying the refinement of patterns of protrusions and recesses.

For example, when a mold is pressed against curable resin on a substrate and then separated therefrom, there is a problem that the protrusions of the pattern on the curable resin are likely to collapse. Therefore, U.S. Patent Application Publication No. 20070132157 discloses a mold in which the peaks of the protrusions within the pattern of protrusions and recesses thereof are rounded, in order to increase the amount of curable resin at the bases of the protrusions within a pattern on curable resin. Thereby, after the curable resin is cured by light, the protrusions of the pattern on the cured resin become waisted due to contraction, decreasing the likelihood of the protrusions collapsing.

### DISCLOSURE OF THE INVENTION

However, even if the mold of U.S. Patent Application Publication No. 20070132157 is utilized, a problem, that the end portions of the protrusions of the pattern on curable resin will collapse when the mold is pressed against the curable resin on a substrate and then separated therefrom, still remains. The mold of U.S. Patent Application Publication No. 20070132157 does not take any special measures with respect to the end portions of the protrusions of patterns on curable resin. Therefore, the technique disclosed in U.S. Patent Application Publication No. 20070132157 does not sufficiently solve this problem. In addition, the technique disclosed in U.S. Patent Application Publication No. 20070132157 is directed to use in nanoimprinting employing photocurable resin, and cannot be applied to nanoimprinting employing a heat curable resin.

The present invention has been developed in view of the foregoing circumstances. It is an object of the present invention to provide a mold for use in nanoimprinting that employs a mold having a predetermined fine pattern of protrusions and recesses on the surface thereof, which is capable of suppressing the collapse of the end portions of protrusions of a pattern on curable resin when the mold is pressed against the curable resin on a substrate then separated therefrom.

To achieve the above object, the present invention provides a nanoimprinting mold having a fine pattern of protrusions and recesses constituted by a plurality of linear protrusions and a plurality of recesses on the surface thereof, characterized by:

the pattern of protrusions and recesses including at least one recess having an end portion of a predetermined shape;

the end portion being a predetermined portion having a length within a range from 10 nm to 50 nm from the end of the recess along the longitudinal direction thereof; and

the predetermined shape being that which has a cross section with a smaller aspect ratio than an aspect ratio of a cross section of a connecting portion, which is a portion of the recess having the end portion other than the end portion and continuous therewith.

In the present specification, the “cross section” that defines the aspect ratio of the recess means a two dimensional region common to a plane perpendicular to the longitudinal direction of the recess and the recess.

The term “aspect ratio” refers to the ratio of the depth of the recess with respect to the width of the recess in the cross section.

In the nanoimprinting mold of the present invention, it is preferable for the predetermined shape to be that in which at least 70% of the end portion has a cross section with a smaller aspect ratio than an aspect ratio of a cross section of the connecting portion.

In the nanoimprinting mold of the present invention, it is preferable for the predetermined shape to be that in which the aspect ratio of the cross section of the end portion becomes smaller in a continuous manner from the connecting portion to the end of the recess.

Alternatively, in the nanoimprinting mold of the present invention, it is preferable for the predetermined shape to be that in which the aspect ratio of the cross section of the end portion is constant throughout the end portion.

In the nanoimprinting mold of the present invention, it is preferable for the predetermined shape to be that in which the width of the recess at the end portion is greater than the width of the recess at the connecting portion.

Alternatively, in the nanoimprinting mold of the present invention, it is preferable for the predetermined shape being that in which the depth of the recess at the end portion is shallower than the depth of the recess at the connecting portion.

In the nanoimprinting mold of the present invention, it is preferable for the aspect ratio of the cross section of the connecting portion to be greater than 3.

In the nanoimprinting mold of the present invention, it is preferable for the pattern of protrusions and recesses to include at least one recess having a width of 30 nm or less.

The mold of the present invention is a nanoimprinting mold having a fine pattern of protrusions and recesses constituted by a plurality of linear protrusions and a plurality of recesses on the surface thereof. The pattern of protrusions and recesses includes at least one recess having an end portion of a predetermined shape. The end portion is a predetermined portion having a length within a range from 10 nm to 50 nm from the end of the recess along the longitudinal direction thereof. The predetermined shape is that which has a cross section with a smaller aspect ratio than an aspect ratio of a cross section of a connecting portion, which is a portion of the recess having the end portion other than the end portion and continuous therewith. This configuration improves the rigidity of the end portions of protrusions of a pattern on curable resin, having a shape corresponding to the pattern of protrusions and recesses of the mold, corresponding to the end portion of the recess of the mold. As a result, the collapse of the end portions of protrusions of a pattern on curable resin can be suppressed when the mold is pressed against the curable resin on a substrate then separated therefrom, during nanoimprinting employing the mold having the predetermined fine pattern of protrusions and recesses on the surface thereof.

### BRIEF DESCRIPTION OF THE DRAWINGS

FIG. 1A is a sectional diagram that schematically illustrates a mold according to the present invention.

FIG. 1B is a partial magnified view that illustrates a cross section of a portion of a pattern of protrusions and recesses of the mold of FIG. 1A.

FIG. 2A is a plan view that schematically illustrates an end portion having a predetermined shape of a recess of a pattern of protrusions and recesses of a mold according to a first embodiment of the present invention.

FIG. 2B is a plan view that schematically illustrates an end portion having a predetermined shape of a recess of a pattern of protrusions and recesses of a mold according to a second embodiment of the present invention.

FIG. 2C is a plan view that schematically illustrates an end portion having a predetermined shape of a recess of a pattern of protrusions and recesses of a mold according to a third embodiment of the present invention.

FIG. 2D is a plan view that schematically illustrates an end portion having a predetermined shape of a recess of a pattern of protrusions and recesses of a mold according to a fourth embodiment of the present invention.

FIG. 2E is a plan view that schematically illustrates an end portion having a predetermined shape of a recess of a pattern of protrusions and recesses of a mold according to a fifth embodiment of the present invention.

FIG. 2F is a plan view that schematically illustrates an end portion of a recess of a pattern of protrusions and recesses of a conventional mold.

FIG. 3 is a sectional diagram that schematically illustrates a pattern of protrusions and recesses in which a plurality of the end portions of FIG. 2C and FIG. 2D are combined.

FIG. 4A is a sectional diagram that schematically illustrates an end portion having a predetermined shape of a recess of a pattern of protrusions and recesses of a mold according to a sixth embodiment of the present invention.

FIG. 4B is a sectional diagram that schematically illustrates an end portion having a predetermined shape of a recess of a pattern of protrusions and recesses of a mold according to a seventh embodiment of the present invention.

FIG. 4C is a sectional diagram that schematically illustrates an end portion of a recess of a pattern of protrusions and recesses of a conventional mold.

FIG. 5 is a collection of sectional diagrams that schematically illustrates the steps for producing a mold in which the depths of recesses vary at the end portions thereof.

### BEST MODE FOR CARRYING OUT THE INVENTION

Hereinafter, an embodiment of the present invention will be described with reference to the attached drawings. However, the present invention is not limited to the embodiments to be described below. Note that the dimensional scale ratios, etc. of the constituent elements within the drawings are not necessarily as the actual scale ratios in order to facilitate visual understanding.

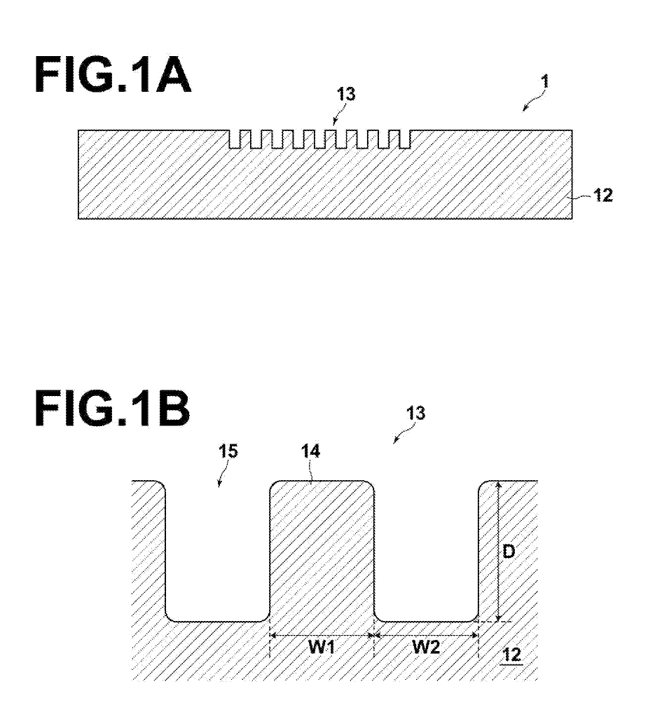

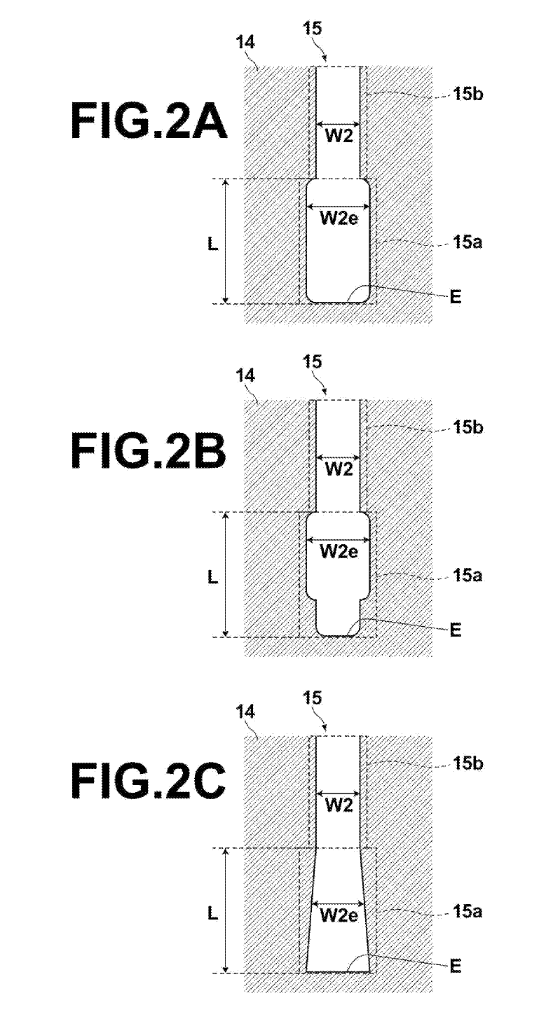

FIG. 1A is a sectional diagram that schematically illustrates a mold according to the present invention. FIG. 1B is a partial magnified view that illustrates a cross section of a portion of a pattern of protrusions and recesses of the mold of FIG. 1A. FIGS. 2A through 2E are sectional diagrams that illustrate examples of end portions having predetermined shapes of recesses of the pattern of protrusions and recesses of the mold.

The mold 1 is constituted by a support portion 12 and the fine pattern 13 of protrusions and recesses formed on a surface of the support portion 12 as illustrated in FIG. 1A and FIG. 1B. At least one of the recesses 15 has an end portion 15a having a predetermined shape. Here, the end portion 15a is a predetermined portion (within the range indicated by reference letter L of FIG. 2A, etc.) having a length within a range from 10 nm to 50 nm from the end of the recess along the longitudinal direction thereof. The predetermined shape is that which has a cross section with a smaller aspect ratio than an aspect ratio of a cross section of a connecting portion 15b, which is a portion of the recess 15 having the end portion 15a other than the end portion 15a and continuous therewith.

The material of the mold 1 may be silicon; a metal, such as nickel, copper, aluminum, molybdenum, cobalt, chrome, steel, tantalum, palladium, tungsten, platinum, and gold; oxides, nitrides and carbides of such metals; or resin. Specific examples of the material of the mold include: silicon oxide, aluminum oxide, quartz glass, Pyrex™, glass, and soda glass. Accordingly, the mold of the present invention is not limited to a specific nanoimprinting method, and may be applied to: thermal imprinting that transfers patterns onto heat curable resin; optical imprinting that transfers patterns onto photocurable resin; room temperature imprinting that transfers patterns onto HSQ (Hydrogen Silses Quioxane) that does not require heat or light; sol gel imprinting that transfers patterns onto glass material in a gel state; direct imprinting that transfers patterns directly onto metal and glass; etc. A material suited to each of the nanoimprinting methods above is selected as appropriate as the material of the mold.

The shape of the pattern 13 of protrusions and recesses is not particularly limited, and may be selected as appropriate according to the intended use of the nanoimprinting mold. The pattern 13 of protrusions and recesses is of a shape in which portions of the surface of the support portion 12 are removed as a plurality of linear recesses 15. That is, the recesses 15 of the pattern of protrusions and recesses refer to spaces sandwiched between pairs of adjacent protrusions 14. Note that there are cases in which a protrusion 14 is connected to another protrusion 14 at the end portion thereof. In such cases, each of the protruding portions are separated from the connected portions and referred to as single protrusions 14.

An example of a typical pattern is a line and space pattern as illustrated in FIG. 1A and FIG. 1B. The length of the recesses 15 (the length in the direction perpendicular to the drawing sheet of FIG. 1B), the interval W1 among the recesses 15 (the width of the protrusions 14), the width of the recesses 15 at portions other than the end portions thereof W2 (the distance among the protrusions 14), and the depth D of the recesses 15 (the height of the protrusions from the bottoms of the recesses 15) are set as appropriate in the line and space pattern. For example, the interval W1 among the recesses 15 is within a range from 10 nm to 100 nm, more preferably within a range from 20 nm to 70 nm, the width W2 of the recesses 15 is within a range from 10 nm to 500 nm, more preferably within a range from 20 nm to 100 nm, and the depth D of the recesses 15 is within a range from 10 nm to 500 nm, more preferably within a range from 30 nm to 100 nm. The advantageous effects of the present invention are more significantly exhibited in the case that the aspect ratio of the cross section of the recesses 15 at portions other than the end portions thereof is greater than 3, and in the case that the width of the recesses 15 at portions other than the end portions thereof is 30 nm or less.

The pattern 13 of protrusions and recesses includes at least one recess 15 having an end portion 15a of a predetermined shape.

The recess 15 may have the end portion 15a of the predetermined shape at one end thereof, or at both ends thereof. The end portions 15a are provided as measures to suppress collapsing of the end portions of protrusions of patterns on curable resin, when the mold is pressed against the curable resin and then separated therefrom. The aspect ratio of the end portions may be decreased to impart rigidity to the end portions, in order to suppress collapsing of the end portions. Therefore, in the present invention, the aspect ratio of the end portions 15a of recesses 15 within the pattern of protrusions and recesses of the mold, which correspond to the end portions of the protrusions of the pattern on the curable resin, is made to be smaller than the aspect ratio of connecting portions 15b. The connecting portions 15b are portions in the vicinity of the end portions 15a and continuous therewith, as illustrated in FIG. 2A, etc.

The end portion 15a is a predetermined portion having a length within a range from 10 nm to 50 nm from the end E of the recess 15 along the longitudinal direction thereof. The length of the end portion 15a is set to these values because sufficient collapse suppressing effects cannot be obtained if the length of the end portion 15a is shorter than 10 nm, and shifting from a desired pattern will become significant if the length of the end portion 15a is greater than 50 nm. The end E of the recess 15 is the end along the recess 15 defined by the mold 1 along the longitudinal direction thereof. Meanwhile, it is preferable for end portion 15a to occupy at least 70% of the range set as described above. It is more preferable for the end portion 15a to occupy 80% or more of the range, and most preferable for the end portion 15a to occupy 90% or more of the range.

Examples of the predetermined shape are those illustrated in FIG. 2A through FIG. 2E. Specifically, FIG. 2A is a diagram that schematically illustrates an end portion 15a having a constant width W2e which is greater than the width W2 of a connecting portion 15b other than at the rounded corners thereof. FIG. 2B is a diagram that schematically illustrates an end portion 15a in which 70% of the end portion 15a has a constant width W2e which is greater than the width W2 of a connecting portion 15b. FIG. 2C is a diagram that schematically illustrates an end portion 15a, in which the width W2e is the same as the width W2 of a connecting portion 15b at the boundary between the connecting portion 15b and the end portion 15a, but increases in a tapered manner from the boundary toward the end E. FIG. 2D is a diagram that schematically illustrates an end portion 15a, in which the width W2e at the boundary with a connecting portion 15b is greater than the width W2 of the connecting portion 15b, and decreases in a tapered manner from the boundary toward the end E. In this case, it is preferable for the width W2e of the end portion 15a at the end E to be greater than or equal to the width W2 of the connecting portion 15b. FIG. 2E is a diagram that schematically illustrates an end portion 15a, in which the width W2e is the same as the width W2 of a connecting portion 15b at the boundary between the connecting portion 15b and the end portion 15a, but increases and then decreases in a continuous manner from the boundary toward the end E. In the above examples, only the widths W2e of the end portions 15a were changed without changing the depths of the recesses at the end portions 15a such that cross sections of the end portions 15a have smaller aspect ratios than those of cross sections of the connecting portions 15b. Note that FIG. 2F is a diagram that schematically illustrates a conventional recess 15 which does not have an end portion of a predetermined shape.

The pattern 13 of protrusions and recesses may include a plurality of recesses 15 having end portions 15a having predetermined shapes different from each other. In this case, it becomes possible to design the pattern 13 of protrusions and recesses such that end portions 15a having shapes complementary to each other can be placed adjacent to each other. Thereby, space can be efficiently utilized even if the pattern 13 of protrusions and recesses becomes very fine.

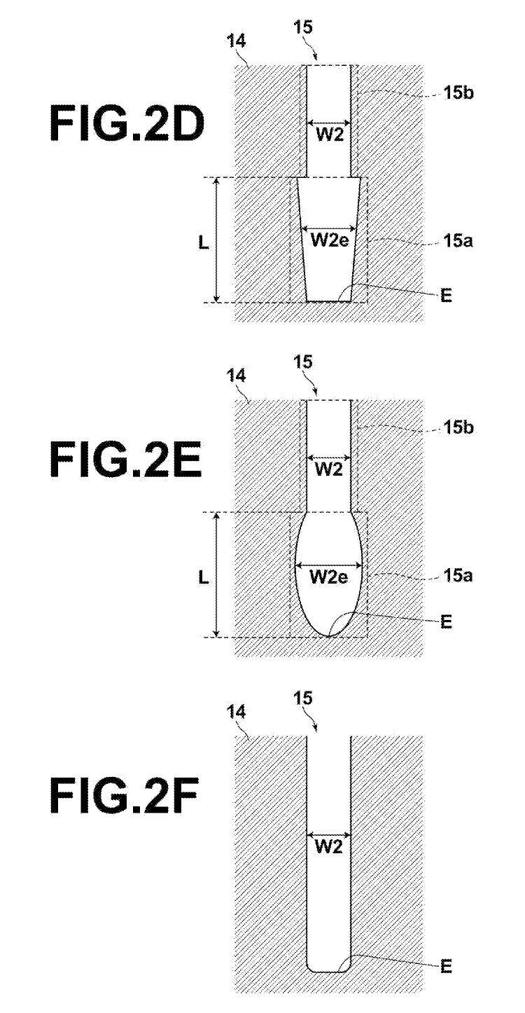

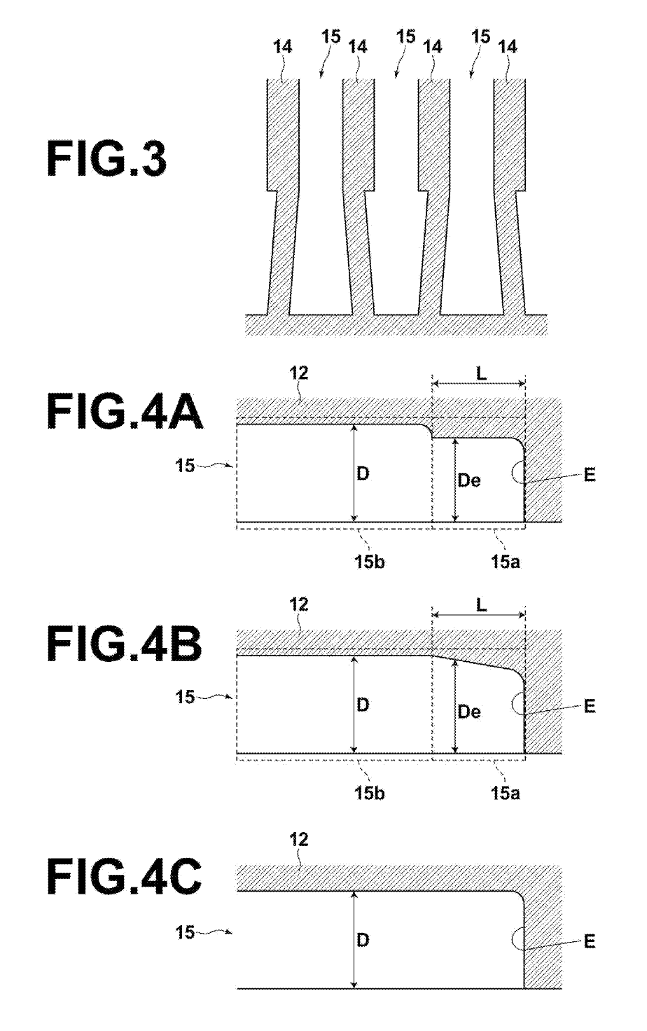

Alternatively, an end portion 15a may be configured such that a cross section thereof has a smaller aspect ratio than that of a cross section of a connecting portion 15b by changing only the depths of the recess 15 at the end portion 15a without changing the width W2e thereof. Examples of such predetermined shapes are illustrated in FIG. 3A and FIG. 4B. Specifically, FIG. 4A is a diagram that schematically illustrates an end portion 15a having a constant depth De shallower than the depth of a connecting portion 15b other than at a rounded corner thereof. FIG. 4B is a diagram that schematically illustrates an end portion 15a, in which the depth De is the same as the depth D of a connecting portion 15b at the boundary between the connecting portion 15b and the end portion 15a, but becomes shallower in a tapered manner from the boundary toward the end E. Note that FIG. 4C is a diagram that schematically illustrates a conventional recess 15 which does not have an end portion of a predetermined shape.

As a further alternative, both the width W2e and the depth D of the recess 15 at the end portion 15a thereof may be changed.

Hereinafter, an embodiment of a method for producing the mold 1 will be described. The method for producing the mold of the present embodiment includes the steps of forming a resist film constituted by curable resin on a substrate, drawing on the parts of the resist film that correspond to the recesses of the pattern of protrusions and recesses with an electron beam, removing the drawn portion of the resist film by a developing process, then etching the substrate using the remaining resist film as a mask.

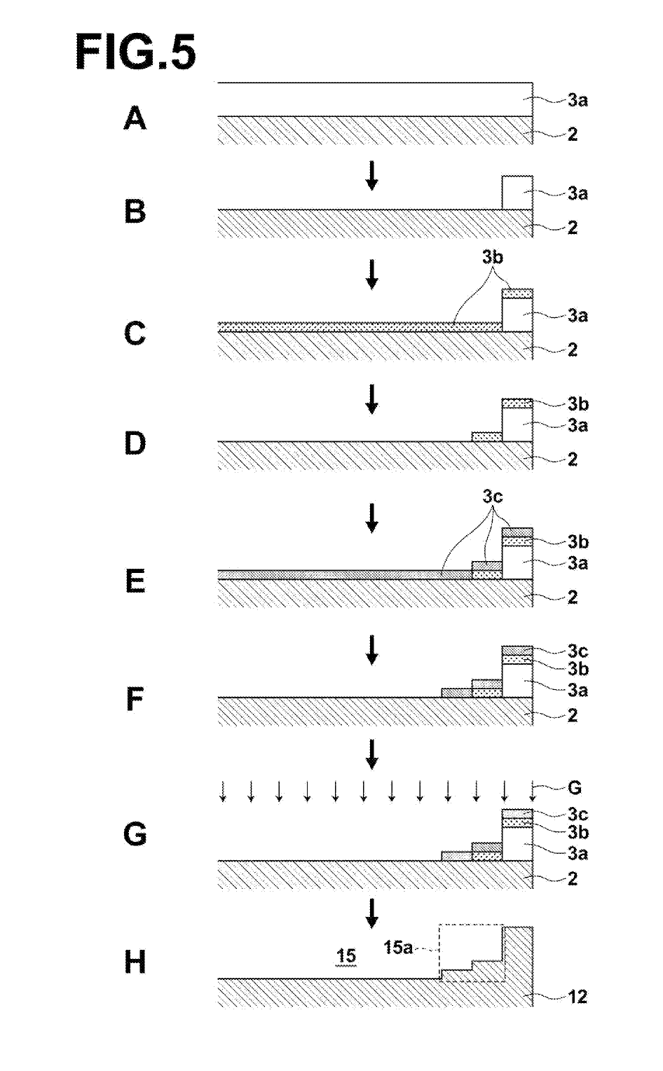

Recesses 15 having varying depths De at the end portions 15a thereof such as those illustrated in FIG. 4A and FIG. 4B may be formed by the following method, for example. First, resist is coated on a substrate 2, which is the base of the mold 1, to form a first resist film 3a (A of FIG. 5). Then, a first lithography operation is executed onto the first resist film 3a at portions corresponding to the recesses 15 of the pattern of protrusions and recesses, and the first resist film 3a is subjected to a developing process (B of FIG. 5). Next, resist is coated onto the first resist film 3a to form a second resist film 3b (C of FIG. 5). Then, a second lithography operation is executed onto the second resist film 3b at portions corresponding to the recesses 15 of the pattern of protrusions and recesses, and the second resist film 3b is subjected to a developing process. At this time, the second lithography operation is executed such that the second resist film 3b remains at a portion corresponding to the portion of the end portion 15a at which the depth De is the shallowest (D of FIG. 5). Next, resist is coated onto the second resist film 3b to form a third resist film 3c (E of FIG. 5). Then, a third lithography operation is executed onto the third resist film 3c at portions corresponding to the recesses 15 of the pattern of protrusions and recesses, and the third resist film 3c is subjected to a developing process. At this time, the third lithography operation is executed such that the third resist film 3c remains at a portion corresponding to the portion of the end portion 15a at which the depth De is the next shallowest (F of FIG. 5). Finally, the substrate 2 is etched for a predetermined amount of time used an etching gas G (G of FIG. 5), thereby forming the recess 15 having the end portion 15a of the predetermined shape (H of FIG. 5).

During patterning lithography of the resist film, electron beam resist is selected in the case that an electron beam lithography apparatus is employed, ion beam resist is selected in the case that an ion beam lithography apparatus is employed, and photoresist is selected in the case that a laser beam lithography apparatus is employed. In the case that electron beam resist is selected, for example, patterning lithography of the resist film is performed by exposing and drawing the portions of the resist film corresponding to the pattern of protrusions and recesses, and removing the exposed portions of the resist film by a developing process.

The substrate is etched by a dry etching process. Thereby, a pattern of protrusions and recesses corresponding to the resist patter is formed on the surface of the substrate. Dry etching suppresses undercutting (side etching). Therefore, a dry etching process having vertical anisotropy (movement of ions being biased in the depth direction of the recesses) is preferable. It is preferable for the dry etching process to be a RIE (Reactive Ion Etching) process. It is preferable for the RIE process to be microwave RIE, CCP (Capacitive Coupled Plasma) RIE, helicon wave RIE, ICP (Inductive Coupled Plasma) RIE, or ECR (Electron Cyclotron Resonance) RIE.

The gas to be employed for the dry etching process is selected as appropriate according to the material of the substrate. A gas that includes atoms of the halogen group, such as fluorine, chlorine, and bromine, or mixed gases, such as CF₄, CHF₃, C₂F₆, C₃F₈, C₄F₈, SF₆, Cl₂, BCl₃, HCl, HBr, and I₂, are selected according to the material of the substrate, for example. In addition, gases such as O₂, N₂, H₂, Ar, and He may be added to adjust the etching shape and the selection ratio with respect to the resist. In the case that dry etching is to be administered onto a silicon substrate, for example, it is preferable to employ a gas that includes fluorine, chlorine, or bromine. Alternatively, in the case that dry etching is to be administered onto a substrate formed by aluminum, chrome, or oxides and nitrides thereof; it is preferable to employ a gas that includes chlorine. As a further alternative, in the case that dry etching is to be administered onto a substrate formed by SiO₂, it is preferable to employ a gas that includes fluorine, chlorine, or the like.

### EXAMPLES

Examples of the mold of the present invention will be described below.

### Example 1

First, an 8 inch silicon wafer was prepared as a substrate for an imprinting mold. Next, a positive electron beam resist (ZEP520 by Nippon Zeon K. K.) was coated on the silicon wafer, to form a resist film having a thickness of 50 nm on the silicon wafer. Then, an electron beam lithography apparatus (by Nippon Electron K. K.) was employed to draw portions of the resist film corresponding to (100) linear recesses of the mold at a dose of 20 μC/cm², and a resist pattern was formed by a developing process. Here, when the end portions of the recesses of the mold were drawn in the lithography step of the resist film, the amount of time that the electron beam was irradiated onto the end portions was 10% longer than the amount of time that the electron beam was irradiated onto other portions, because the width of the end portions was approximately 10% greater than the width of the other portions.

Next, the silicon wafer was etched by a vertically anisotropic dry etching method employing an ICP RIE apparatus using the resist film as a mask, to form a pattern of protrusions and recesses on the surface of the silicon wafer. The etching conditions were as follows: the flow volume of Cl₂ was 30scam; the flow volume of O₂ was 5 sccm; the flow volume of Ar was 80 sccm; the pressure inside the apparatus was 2Pa; the ICP power was 400 W; and the RIE power was 130 W. Next, the resist film was removed by an O₂ plasma ashing process, to obtain a silicon mold. The ashing conditions were as follows: the flow volume of O₂ was 500 sccm, the pressure was 30 Pa; and the RF power was 1000 W. The silicon mold produced as this example had end portions having a predetermined shape as illustrated in FIG. 2A.

A nanoimprinting operation was performed as follows. The silicon mold produced in the manner described above was pressed against photocurable resin coated on a quartz substrate. Ultraviolet rays were irradiated through the quartz substrate from back surface thereof to cure the photocurable resin. Thereafter, the silicon mold was separated from the cured resin.

### Example 2

A silicon mold was produced in the same manner as that for Example 1, except that the amount of time that the electron beam was irradiated at the end portions was increased to a maximum of a 10% increase at a rate of 1%/nm, in order to gradually increase the width of the end portions toward the ends thereof. The silicon mold produced as this example had end portions having a predetermined shape as illustrated in FIG. 2C.

A nanoimprinting operation was performed using the silicon mold produced as described above in the same manner as that for Example 1.

### Example 3

An 8 inch silicon wafer was prepared as a substrate for an imprinting mold. Next, a positive electron beam resist was coated on the silicon wafer, to form a first resist film having a thickness of 50 nm on the silicon wafer. Then, an electron beam lithography apparatus was employed to draw portions of the first resist film corresponding to (100) linear recesses of the mold at a dose of 20 μC/cm², and a resist pattern was formed by a developing process. Further, resist was coated again on the resist pattern, to form a second resist film having a thickness of 5 nm. Then, the electron beam lithography apparatus was employed to draw portions of the second resist film corresponding to the recesses of the mold at a dose of 20 μC/cm², and a resist pattern was formed by a developing process. At this time, lithography was executed such that the second resist film remained at portions corresponding to portions of the end portions of the recesses at which the depth is shallow. The resist pattern is that in which the thickness of the resist differs only at portions corresponding to the end portions of the recesses of the mold.

Next, the silicon wafer was etched in the same manner as Example 1, to obtain a silicon mold. The silicon mold produced as this example had end portions having a predetermined shape as illustrated in FIG. 4A.

A nanoimprinting operation was performed in using the silicon mold produced as described above in the same manner as that for Example 1.

### Example 4

An 8 inch silicon wafer was prepared as a substrate for an imprinting mold. Next, a positive electron beam resist was coated on the silicon wafer, to form a first resist film having a thickness of 50 nm on the silicon wafer. Then, an electron beam lithography apparatus was employed to draw portions of the first resist film corresponding to (100) linear recesses of the mold at a dose of 20 μ/cm², and a resist pattern was formed by a developing process. Next, resist was coated again on the resist pattern, to form a second resist film having a thickness of 1 nm. Then, the electron beam lithography apparatus was employed to draw portions of the second resist film corresponding to the recesses of the mold at a dose of 20 μC/cm², and a resist pattern was formed by a developing process. At this time, lithography was executed such that the second resist film remained at portions corresponding to portions of the end portions of the recesses at which the depth is the shallowest. Further, resist was coated again on the resist pattern, to form a third resist film having a thickness of 1 nm. Then, the electron beam lithography apparatus was employed to draw portions of the third resist film corresponding to the recesses of the mold at a dose of 20 μC/cm², and a resist pattern was formed by a developing process. At this time, lithography was executed such that the third resist film remained at portions corresponding to the next shallowest portions of the end portions of the recesses. A plurality of steps similar to the formation of the third resist layer, the lithography operation, and the development process were repeated. The resist pattern is that in which the thickness of the resist at portions corresponding to the end portions of the recesses of the mold change substantially continuously.

Next, the silicon wafer was etched in the same manner as Example 1, to obtain a silicon mold. The silicon mold produced as this example had end portions having a predetermined shape as illustrated in FIG. 4A.

A nanoimprinting operation was performed in using the silicon mold produced as described above in the same manner as that for Example 1.

### Comparative Example

An 8 inch silicon wafer was prepared as a substrate for an imprinting mold. Next, a positive electron beam resist was coated on the silicon wafer, to form a resist film having a thickness of 50 nm on the silicon wafer. Then, an electron beam lithography apparatus was employed to draw portions of the resist film corresponding to (100) linear recesses of the mold at a dose of 20 μC/cm², and a resist pattern was formed by a developing process. Here, while drawing the recesses of the mold in the lithography step, the amount of time that the electron beam was irradiated onto the end portions was kept constant.

Next, the silicon wafer was etched in the same manner as Example 1, to obtain a silicon mold.

A nanoimprinting operation was performed in using the silicon mold produced as described above in the same manner as that for Example 1.

### <Results>

Table 1 indicates the number of protrusions of a pattern on cured resin that collapsed when the molds of Examples 1 through 4 and the Comparative Example were separated therefrom during the nanoimprinting operations described above. In the case that the mold of the Comparative Example was employed, 70 of 100 protrusions collapsed. In contrast, none of the protrusions collapsed in the cases that the molds of Examples 1 through 4 were employed. These results confirmed that the mold of the present invention can suppress collapsing of the end portions of protrusions of patterns on cured resin when the mold is pressed against curable resin on a substrate then separated therefrom.

TABLE 1

| Mold | Number of Collapsed Protrusions |
|---|---|
| Example 1 | 0 |
| Example 2 | 0 |
| Example 3 | 0 |
| Example 4 | 0 |
| Comparative Example | 70 |

What is claimed is:

1. A nanoimprinting mold having a fine pattern of protrusions and recesses constituted by a plurality of linear protrusions and a plurality of recesses on the surface thereof, wherein:
the pattern of protrusions and recesses include at least one recess having an end portion of a predetermined shape;
the end portion is a predetermined portion having a length within a range from 10 nm to 50 nm from the end of the recess along the longitudinal direction thereof;
the longitudinal direction of the recesses is a direction perpendicular to the width direction of the recesses, which is the direction of the intervals among the protrusions of the pattern of protrusions and recesses, and perpendicular to the depth directon of the recesses; and
the predetermined shape being that which has a cross section with a smaller aspect ratio than an aspect ratio of a cross section of a connecting portion, which is a portion of the recess having the end portion other than the end portion and continuous therewith.

2. A nanoimprinting mold as defined in claim 1, wherein:
the predetermined shape is that in which at least 70% of the end portion has a cross section with a smaller aspect ratio than an aspect ratio of a cross section of the connecting portion.

3. A nanoimprinting mold as defined in claim 2, wherein:
the predetermined shape is that in which the aspect ratio of the cross section of the end portion becomes smaller in a continuous manner from the connecting portion to the end of the recess.

4. A nanoimprinting mold as defined in claim 2, wherein:
the predetermined shape is that in which the aspect ratio of the cross section of the end portion is constant throughout the end portion.

5. A nanoimprinting mold as defined in claim 1, wherein:
the predetermined shape is that in which the width of the recess at the end portion is greater than the width of the recess at the connecting portion.

6. A nanoimprinting mold as defined in claim 2, wherein:
the predetermined shape is that in which the width of the recess at the end portion is greater than the width of the recess at the connecting portion.

7. A nanoimprinting mold as defined in claim 3, wherein:
the predetermined shape is that in which the width of the recess at the end portion is greater than the width of the recess at the connecting portion.

8. A nanoimprinting mold as defined in claim 4, wherein:
the predetermined shape is that in which the width of the recess at the end portion is greater than the width of the recess at the connecting portion.

9. A nanoimprinting mold as defined in claim 1, wherein:
the predetermined shape is that in which the depth of the recess at the end portion is shallower than the depth of the recess at the connecting portion.

10. A nanoimprinting mold as defined in claim 2, wherein:
the predetermined shape is that in which the depth of the recess at the end portion is shallower than the depth of the recess at the connecting portion.

11. A nanoimprinting mold as defined in claim 3, wherein:
the predetermined shape is that in which the depth of the recess at the end portion is shallower than the depth of the recess at the connecting portion.

12. A nanoimprinting mold as defined in claim 4, wherein:
the predetermined shape is that in which the depth of the recess at the end portion is shallower than the depth of the recess at the connecting portion.

13. A nanoimprinting mold as defined in claim 5, wherein:
the predetermined shape is that in which the depth of the recess at the end portion is shallower than the depth of the recess at the connecting portion.

14. A nanoimprinting mold as defined in claim 1, wherein:
the aspect ratio of the cross section of the connecting portion is greater than 3.

15. A nanoimprinting mold as defined in claim 2, wherein:
the aspect ratio of the cross section of the connecting portion is greater than 3.

16. A nanoimprinting mold as defined in claim 3, wherein:
the aspect ratio of the cross section of the connecting portion is greater than 3.

17. A nanoimprinting mold as defined in claim 4, wherein:
the aspect ratio of the cross section of the connecting portion is greater than 3.

18. A nanoimprinting mold as defined in claim 1, wherein:
the pattern of protrusions and recesses includes at least one recess having a width of 30 nm or less.

19. A nanoimprinting mold as defined in claim 2, wherein:
the pattern of protrusions and recesses includes at least one recess having a width of 30 nm or less.

20. A nanoimprinting mold as defined in claim 3, wherein:
the pattern of protrusions and recesses includes at least one recess having a width of 30 nm or less.
